(19) United States
(12) Patent Application Publication
(10) Pub. No.: US 2026/0162419 A1
(43) Pub. Date: Jun. 11, 2026

(54) 3D GAUSSIAN FEATURE OPTIMIZATION BY DISTILLATION FROM 2D FOUNDATION MODELS

(71) Applicant: NVIDIA Corp., Santa Clara, CA (US)

(72) Inventors: Yang Fu, San Diego, CA (US); Chao Liu, Santa Clara, CA (US); Sifei Liu, San Diego, CA (US); Ben Eckart, Oakland, CA (US); Arash Vahdat, San Mateo, CA (US); Xiaolong Wang, San Diego, CA (US)

(73) Assignee: NVIDIA Corp., Santa Clara, CA (US)

(21) Appl. No.: 19/415,386

(22) Filed: Dec. 10, 2025

Related U.S. Application Data
(60) Provisional application No. 63/730,872, filed on Dec. 11, 2024.

(51) Int. Cl. G06V 10/82; G06V 10/74; G06V 10/77

(52) U.S. Cl. CPC G06V 10/82; G06V 10/761; G06V 10/7715

(57) ABSTRACT

Generalizable feature distillation systems that align 3D features with 2D foundation model features using a feedforward network, avoiding per-scene optimization, and a flexible end-to-end 3D scene interpretation system that applies the extracted 3D features and pretrained 2D vision-language models for various 3D scene understanding tasks.

### CROSS-REFERENCE TO RELATED APPLICATIONS

This application claims priority and benefit of U.S. application Ser. No. 63/730,872, “Amortized 3D Gaussian Feature Optimization by Distillation from 2D Foundation Models”, filed on Dec. 11, 2024, the contents of which are incorporated herein by reference in their entirety.

### BACKGROUND

Recently, the 3D Gaussian Splatting (3DGS) has gained significant attention in the field of 3D reconstruction and rendering due to its efficiency, effectiveness and interpretability. Although efforts have been made for improvement in terms of scalability, rendering quality and intractability, there is still little work on adapting 3D Gaussian splatting for generalizable semantic understanding and generalization to unseen data.

Existing methods to incorporate semantic understanding with 3D Gaussian splatting mainly focus on single-scene based optimization and suffer from long optimization time and lack of generalizability.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts a system in accordance with one embodiment.

FIG. 2 depicts an example of a process of distillation through two-dimensional (2D) feature rendering.

FIG. 3 depicts an example of a process of feature distillation through three-dimensional (3D) uplifting from 2D scene features.

FIG. 4 depicts an example of uplifting the 2D features into 3D Gaussian splats.

FIG. 5 depicts the use of pretrained adaptors in a vision language model, in one embodiment.

FIG. 6 depicts the use of feature-enhanced 3D Gaussians for video generation, in one embodiment.

FIG. 7 depicts a parallel processing unit in accordance with one embodiment.

FIG. 8 depicts a general processing cluster in accordance with one embodiment.

FIG. 9 depicts a memory partition unit in accordance with one embodiment.

FIG. 10 depicts a streaming multiprocessor in accordance with one embodiment.

FIG. 11 depicts a processing system in accordance with one embodiment.

FIG. 12 depicts an exemplary processing system in accordance with another embodiment.

### DETAILED DESCRIPTION

Scene understanding involves recognizing and interpreting objects and their spatial relationships within a 3D environment. Configuring comprehensive scene understanding into artificial intelligence systems that utilize 3D Gaussian splatting presents two significant challenges: 1) incorporating semantic understanding and 2) generalizing the semantic understanding to unseen scenes.

Disclosed herein are mechanisms for 3D Gaussian feature optimizations utilizing feature distillation from large-scale 2D foundation models. Examples of 2D foundation models include CLIP, DINO, and RADIO.

The CLIP (Contrastive Language-Image Pretraining) connects images and text via training on hundreds of millions of image-caption pairs from the web. It's a vision-language model (VLM) that jointly embeds images and text into a shared feature space.

DINO (Self-Distillation with No Labels) learns visual features from unlabeled images using self-distillation, meaning it teaches itself by predicting the output of another network trained on the same data.

RADIO refers to a variety of 2D foundational model described for example in Ranzinger et al, “Am-radio: Agglomerative vision foundation model reduce all domains into one”, Proceedings of the IEEE/CVF Conference on Computer Vision and Pattern Recognition (CVPR), pages 12490-12500, 2024. RADIO's backbone features may be projected into various target embedding spaces, e.g., DINO, CLIP, and SAM (Segment Anything Model) using pretrained, lightweight adapters.

Knowledge distillation is the process of transferring knowledge from a large, powerful model (teacher) into a smaller, more efficient model (student). Instead of training the student on raw labels, it's trained to mimic the teacher's outputs or internal features, which tend to be smoother and often encode generalizations that labels alone can't. Feature distillation is a process of configuring the student model to match the hidden layer activations (features) of the teacher model.

During training of the student model, the same inputs are applied into both models. A set of intermediate feature maps or embeddings are extracted from the teacher. A loss function (like L2 distance or cosine similarity) is determined between the teacher's and student's features and the student model's parameters are updated to minimize that feature difference.

Disclosed herein are mechanisms to configure a 3D feature extraction network via training to extract semantic features from 3D Gaussian splats. The network is trained by distill features from 2D foundation models. A training set for the network may comprise image-scene aligned data, with diverse scenes, and 3D Gaussian splatting reconstructions.

The disclosed mechanisms comprise a generalizable feature distillation frame-work that aligns 3D Gaussian features with 2D foundation model features using a feedforward network, avoiding the need for per-scene optimization. A flexible end-to-end 3D scene understanding pipeline applies the extracted 3D features and pretrained 2D vision-language models for various 3D scene understanding tasks.

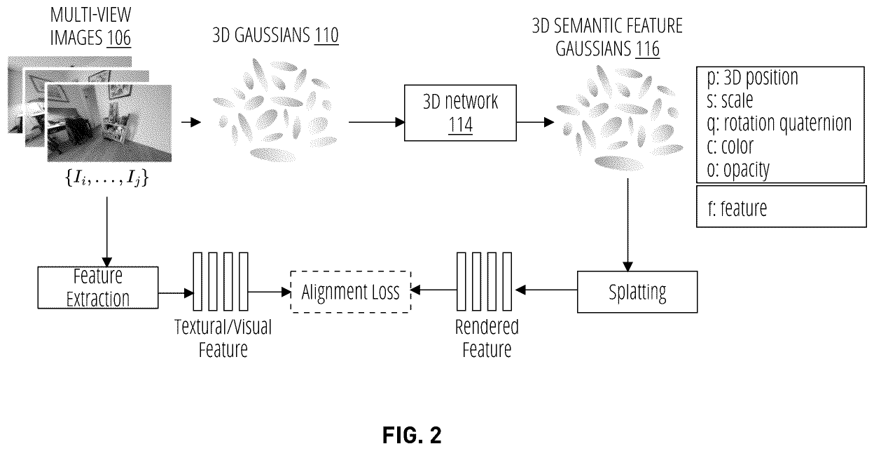

The 3D feature extraction network (a network trained to process 3D inputs) comprises a feedforward transformer-based network that processes 3D Gaussian splatting representations to produce semantic features. An exemplary transformer-based network that may be utilized for this purpose is PointTransformer (see FIG. 2).

The 3D feature extraction network attaches semantic features—such as dense CLIP, DINOv2, and SAM—to the 3D Gaussian splatting representations. Feature knowledge may be distilled from large-scale 2D foundation models and aligned with their 3D Gaussian splatting feature counterparts. The disclosed mechanisms may be utilized for example to provide zero-shot enhancement of 2D multi-modal models for 3D scene understanding without fine-tuning, preserving the model's generalizability while enabling 3D reasoning capabilities.

Multi-view fusion refers to combining information from multiple views (camera perspectives) of the same underlying objects/scene. Fusion is the process of combining or aligning these different perspectives into a single unified feature representation. By fusing multiple 2D views to reconstruct a 3D scene, the network learns to project and aggregate features from each view into a shared 3D latent space. For example, multiple camera views of each object or scene may be generated, passed through an encoder to produce feature embeddings, and processed through a mechanism such as attention pooling, a transformer cross-view encoder, or voxel aggregation to merge features.

A first step is to reconstruct the indoor scenes via 3D Gaussian Splatting. A scene may be represented with a set of 3D Gaussians

$$𝒢 = {\{ {( μ , SH , r , s , α )}_{i} \}}_{i = 1 : M}$$

where (a) μ∈ [symbol] ³ is the 3D mean of the Gaussian, (b) SH∈ [symbol] ^{(k+1)}^{²}^{×3} are the spherical harmonics (SH) coefficients that represent the Gaussian color, (c) r∈ [symbol] ⁴ is its quaternion rotation factor, (d) s∈ [symbol] ³ is the Gaussian scale and (e) α∈ [symbol] is the Gaussian opacity.

The covariance matrix Σ describes an ellipsoid configured by a scaling matrix S=diag(s) and rotation matrix R=q2R(r), where q2R(·) is the expression for constructing a rotation matrix from a quaternion. The covariance matrix can be computed as Σ=RSS^{T}R^{T}. The rendered color may be formulated as the alpha-blending of N ordered points that overlap the pixel as

$${c}_{pix} = {\sum }_{i}^{N} {SH}_{i} {α}_{i} {\prod }_{j}^{i - 1} ( 1 - {α}_{j} )$$

where αᵢ represents the density of this Gaussian computed from the per-Gaussian opacity weighted by the Gaussian covariance Σ (ignored in Eq. 2 for simplicity).

The Gaussian positions may be initialized from the ground-truth scene mesh vertices. To reduce the number of initialized Gaussians, grid subsampling may be performed with a set voxel size (e.g., 2 cm) on the original mesh. The Gaussian growing step may be skipped with pruning performed during optimization.

For a given set of 3D Gaussians, a next step is to extract per-Gaussian features. A multi-view feature fusion mechanism (multi-view fusion logic 102) may be utilized while lifting 2D feature maps into 3D Gaussian space. Backbone features may be extracted from a 2D foundation model, e.g., RADIO.

For each Gaussian g from the set of Gaussians [symbol] , the disclosed mechanisms may first project the Gaussian onto the image plane using the camera intrinsics Kⱼ and world-to-camera extrinsics Eⱼ of the j^{th} frame. The corresponding pixel coordinate may be calculated as u=Kⱼ·Eⱼ·g(μ) (the homogeneous representations of u and μ are omitted for simplicity). Occlusion testing may be performed to help ensure that only visible Gaussians are considered by comparing them with the rendered depth map.

Given the projected pixel coordinate u, the corresponding feature may be obtained via fⱼ=Fⱼ[u] where Fⱼ∈ [symbol] ^{H,W,D} is the backbone feature map and D refers to the feature dimension. Assuming N views are available for fusion, the fused feature vector for Gaussian g may be computed as the mean of the corresponding features across these N views: f_{fused}=mean(f₁, . . . , f_{N})

By repeating this fusion process for each Gaussian, a feature-enriched 3D Gaussian set is established: [symbol] _{fused}={(f_{used}, μ, SH, r, s, α)ᵢ}_{i=1:M}.

Knowledge may be distilled from the 2D foundation model into a 3D network that takes a set of 3D Gaussians as input. Given a set of 3D Gaussians [symbol] , a network ε_{3D} may be trained to output per-Gaussian embeddings

$$= ( 𝒢 ) ,$$

$$where$$

$${F}_{3 D} = , … , \} .$$

A view-dependent selection strategy may be implemented to reduce the number of input Gaussians after voxelization. First sample several target views and construct view frustums from their camera extrinsics. Then filter out Gaussians outside these view frustums, using the remaining Gaussians as input for the 3D network. PointTransformer V3 [69] may be utilized as the 3D backbone network [symbol] and change its output dimension to 3D.

To ensure consistency between output features and fused features, a cosine similarity loss may be applied. To enable pre-trained adapters embedding adaptor 502 to serve as drop-in replacements for mapping features to different target embedding spaces, the magnitude of feature vectors may be maintained using smooth L1 loss. A combination of cosine similarity and smooth L1 may be implemented as

$${ℒ}_{match} ( x , y ) = α ( 1 - cos ( x , y ) ) + {βℒ}_{11 - smooth} ( x , y )$$

$${ℒ}_{3 D} = {\sum }_{i}^{M} {ℒ}_{match} ( {f}_{3 D}^{i} , {f}_{used}^{i} )$$

where α, β are two balance factors. In one embodiment, empirically set α=0.9 and β=0.1. To further ensure that the distilled features remain compatible with pretrained adapters, the same matching loss may be applied between the 2D rendered feature maps and the features extracted from the 2D model after processing both through pretrained adapter dh,

$${ℒ}_{render} = {\sum }_{h}^{H} {\sum }_{j}^{N} {ℒ}_{match} ( {Φ}_{h} ( R ( {𝒢}_{fused} , {K}_{j} , {E}_{j} ) ) , {Φ}_{h} ( {F}_{j} ) )$$

where R is the feature rendering process from the given camera parameters and His the number of adapters. Therefore, the final loss function may be expressed as,

$${ℒ}_{distill} = {λ}_{3 D} {ℒ}_{3 D} + {λ}_{render} {ℒ}_{render}$$

where λ_{3D} and λ_{render} may for example be set to 1.0, 0.2, respectively.

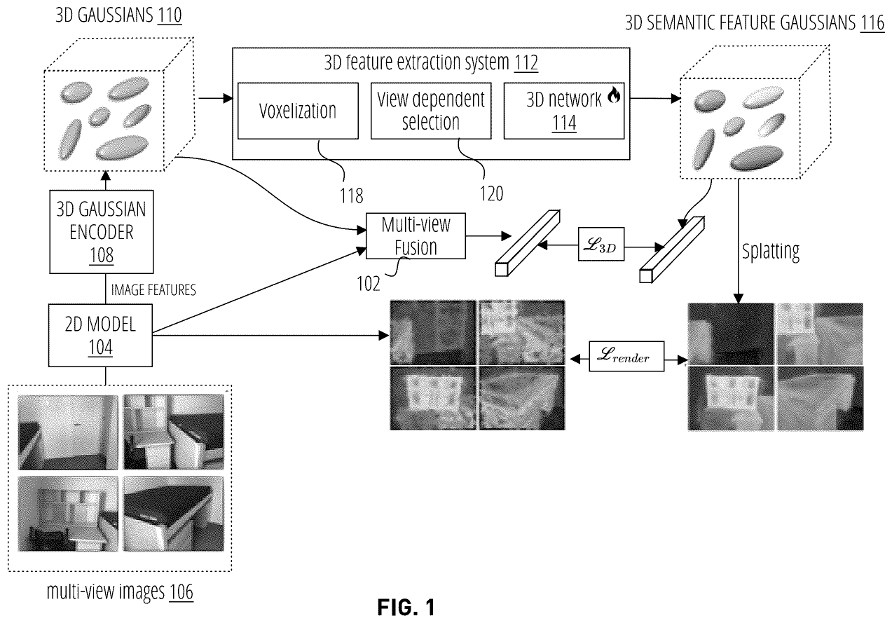

FIG. 1 depicts a 3D feature Gaussian distillation system in one embodiment. A set of 3D Gaussians is reconstructed from multi-view images. A 3D Gaussian splatting maps each Gaussian to a semantic feature space. A view-dependent selection strategy based on camera frustums identifies Gaussians contributing to the rendered views. Training of the network is supervised by two distillation losses: L3D applied to 3D Gaussians, and L_{render} applied to 2D rendered feature maps.

A 2D model 104 (a model trained on two-dimensional images or video frames) is utilized to extract image features from multi-view images 106. The image features are processed through a 3D Gaussian encoder 108 to produce 3D Gaussians 110. The 3D Gaussians 110 are processed through a 3D feature extraction system 112 comprising a 3D feature extraction network 114 trained to extract semantic features from the 3D Gaussians 110 in a single forward pass.

Before passing through the 3D feature extraction network 114, the 3D Gaussians 110 may comprise only position and shape parameters. After passing through the 3D feature extraction network 114, the resulting 3D semantic feature Gaussians 116 include additional semantic parameters that may be applied to enable downstream VLM tasks.

Thus, unlike in conventional feature distillation mechanisms, in the disclosed systems the feature distillation from the 2D model 104 to the 3D feature extraction network 114 is routed through and by a set of 3D Gaussians 110 encoding multi-view images 106.

Within the 3D feature extraction system 112, the set of 3D Gaussians 110 may undergo voxelization (voxelizer 118) and view-dependent selection (view-dependent filter 120) to reduce the size of the set. Voxelization refers to the mapping of continuous Gaussians to a fixed 3D grid. For each voxel (a cube in the grid) each Gaussian's overlap/contribution to that voxel is determined, and the voxel's value (density, feature, or color) is the weighted combination of those contributions.

The resulting 3D semantic feature Gaussians 116 tend to be well-aligned with the features recognized by 2D foundation models, obviating the need for task-specific fine-tuning of downstream pretrained models that use them.

The 3D Gaussian encoder 108 generates per-Gaussian feature vectors that are mapped by the 3D feature extraction network 114 to different embedding spaces (i.e., CLIP and SigLIP) via pretrained adapters for open-vocabulary scene understanding and 3D visual grounding. The 3D semantic feature Gaussians 116 comprise feature-augmented 3D Gaussians that are rendered into multiple views. The resulting feature maps, combined with RGB images, may be input to pretrained 2D Language-Multimodal Models (LMMs) for 3D visual query-response tasks.

FIG. 2 depicts a rendering distillation process in one embodiment. 3D Gaussian splatting is performed on a set of images to generate 3D Gaussian splats. Each Gaussian to splat is characterized by its center, covariance, opacity, and color.

The PointTransformer model (e.g., PointTransformerV3, PTv3) is a point-cloud backbone for semantic segmentation, designed to be fast and memory-efficient while scaling to large receptive fields. PTv3 may be utilized to process Gaussians as “points with attributes”, with each Gaussian processed as a point with center u, color/appearance, opacity, scale and anisotropy (e.g., covariance eigenvalues/eigenvectors), and any learned features. The “point set” is then input to PTv3 for per-Gaussian (point-wise) semantic labels.

3D Gaussian splatted scenes may hundreds of thousands or millions of Gaussians. The utilization of tiling/chunking, importance sampling, and or voxel/prior downsampling may be utilized to meet memory and batch size constraints. The disclosed mechanisms achieve open-vocabulary scene understanding by combining semantic labeling from a model such as PTv3 with vision-language features projected to Gaussians (e.g., CLIP-aligned features).

The center of each Gaussian splat may be taken as its 3D location to perform efficient serialized neighbor mapping with the remaining attributes used as feature inputs.

The extracted Gaussian features are splatted onto a 2D plane and compared with the 2D feature map obtained from the 2D foundation models for computation of alignment loss.

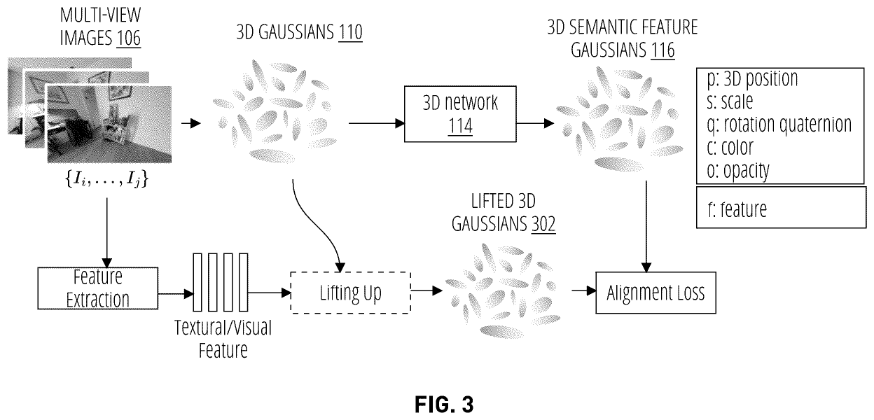

FIG. 3 depicts an uplifting distillation process in one embodiment. 3D Gaussian splatting is performed on a set of images to generate 3D Gaussian splats, with each Gaussian to splat being characterized by its center, covariance, opacity, and color. Image features are extracted (feature extraction) and ‘lifted up’ to three dimensions via back-projection. This results in 3D Gaussians comprising VLM features.

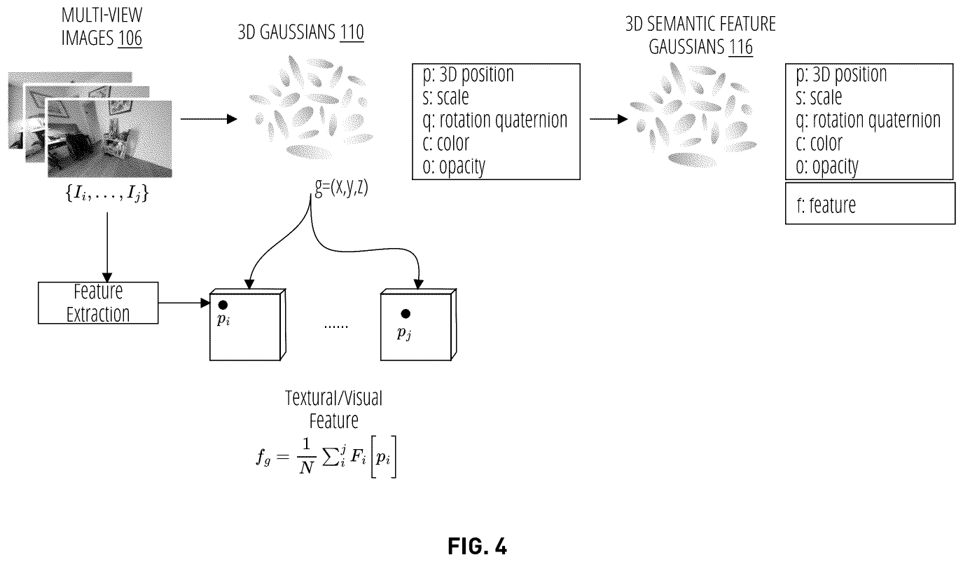

In the uplifting-based mechanism the 2D feature map from the 2D foundation model is lifted into the Gaussian splats. The lifted 3D Gaussians 302 are directly compared with the 3D semantic feature Gaussians 116 obtained from the 3D feature extraction network 114. An example uplifting operation is depicted in FIG. 4. Each Gaussian feature f_{g} is determined as an average of pixel features Fᵢ over N views.

Semantic features extracted from 3D Gaussian splats may be applied to improve the 3D spatial understanding for vision-language models. A Vision-Language Model (VLM) is a type of multimodal artificial intelligence model designed to understand and generate information that combines both visual and textual inputs. A VLM learns joint representations of images (or video frames) and language enabling it to connect visual content with text. A VLM is typically trained on large datasets of image-caption or video-text pairs. A prompt to a VLM often has a form of the kind “Describe what's happening in this picture.”

A VLM may implement a combination of a vision encoder (e.g., a convolutional neural network or vision transformer) that converts images to feature embeddings, and a language model (e.g., GPT or BERT) that interprets text features. The VLM may comprise a cross-modal transformer or attention module that aligns visual and textual features, such as CLIP. The alignment of images and text may take place in a shared embedding space.

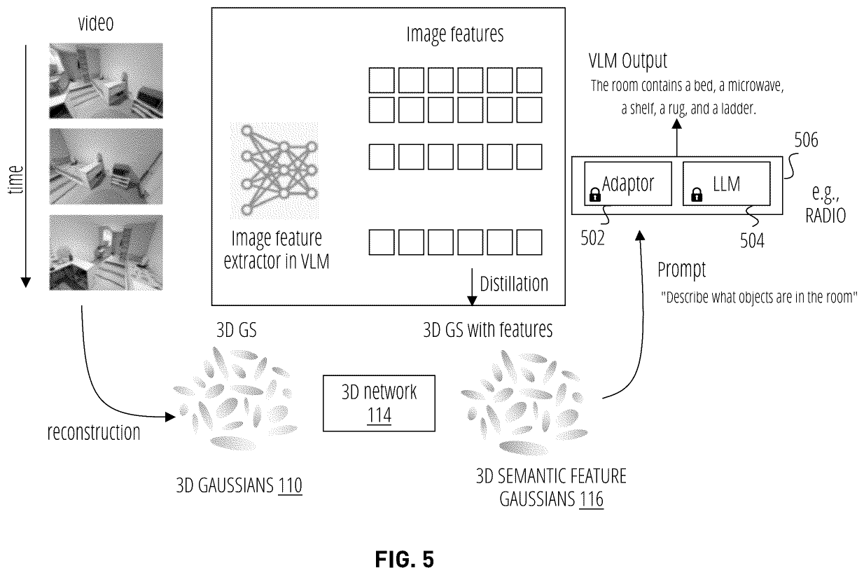

Referring to FIG. 5, features may be extracted from a network that maps input 3D Gaussians to VLM features (e.g. CLIP embedding or VILA image feature). The extracted VLM features are input to a pretrained (and not finetuned) vision language model 506, such that visible 3D structures between distant-in-time video frames may attend to each other (long-range attention), a challenging task for conventional VLM models. The vision language model 506 may comprise a pretrained large language model 504 and a pretrained, interchangeable embedding adaptor 502 to map input features to different target embedding spaces.

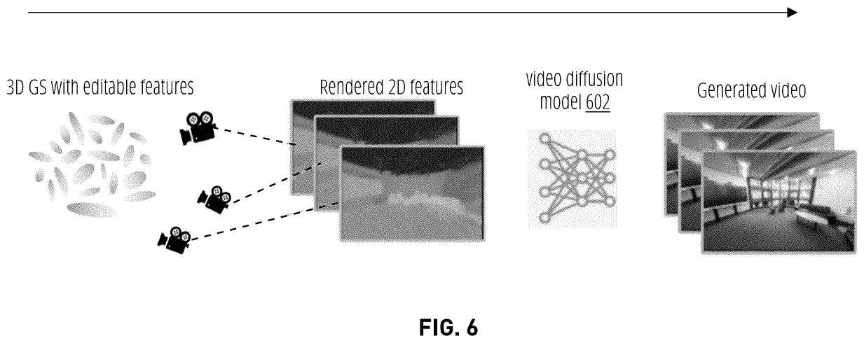

Referring to FIG. 6, the 3D Gaussians with semantic features may serve as a controllable latent representation of a 3D scene, which is useful for controllable video generation tasks. The 3D Gaussian features may be rendered onto 2D images for a desired camera trajectory and a video diffusion model 602 may be conditioned for controlled video generation. The video generation process may be controlled by editing the Gaussian features (e.g. CLIP embeddings), utilizing a video diffusion model to generate the video conditioned on the rendered 2D features.

The mechanisms disclosed herein may be implemented in and/or by computing devices utilizing one or more graphic processing unit (GPU, e.g., comprising parallel processing module 1106) and/or general purpose data processor (e.g., a “central processing unit” or CPU). A graphics processing unit may be a standalone chip or package, or may comprise graphics processing circuitry integrated with a central processing unit. In one embodiment, the disclosed mechanisms may be implemented as machine-readable instructions in a computer memory (e.g., memory 724, main memory 1204) for execution on one or more GPU and/or CPU. Exemplary architectures will now be described that may be configured to implement the mechanisms disclosed herein.

The following description may use certain acronyms and abbreviations as follows:
“DPC” refers to a “data processing cluster”;
“GPC” refers to a “general processing cluster”;
“I/O” refers to a “input/output”;
“L1 cache” refers to “level one cache”;
“L2 cache” refers to “level two cache”;
“LSU” refers to a “load/store unit”;
“MMU” refers to a “memory management unit”;
“MPC” refers to an “M-pipe controller”;
“PPU” refers to a “parallel processing unit”;
“PROP” refers to a “pre-raster operations unit”;
“ROP” refers to a “raster operations”;
“SFU” refers to a “special function unit”;
“SM” refers to a “streaming multiprocessor”;
“Viewport SCC” refers to “viewport scale, cull, and clip”;
“WDX” refers to a “work distribution crossbar”; and
“XBar” refers to a “crossbar”.

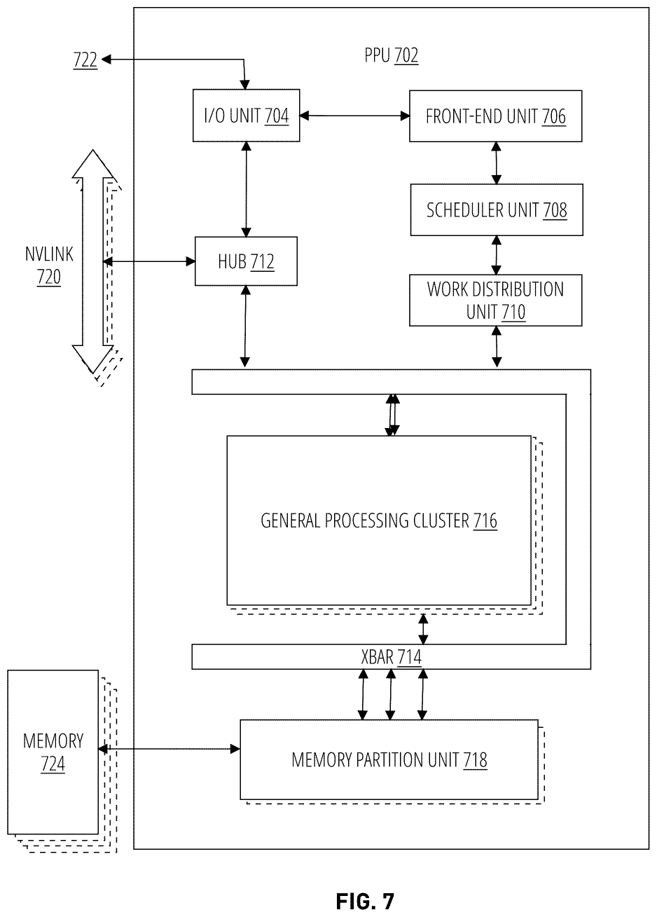

FIG. 7 depicts a parallel processing unit 702, in accordance with an embodiment. In an embodiment, the parallel processing unit 702 is a multi-threaded processor that is implemented on one or more integrated circuit devices. The parallel processing unit 702 is a latency hiding architecture designed to process many threads in parallel. A thread (e.g., a thread of execution) is an instantiation of a set of instructions configured to be executed by the parallel processing unit 702. In an embodiment, the parallel processing unit 702 is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the parallel processing unit 702 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more parallel processing unit 702 modules may be configured to accelerate thousands of High Performance Computing (HPC), data center, and machine learning applications. The parallel processing unit 702 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 7, the parallel processing unit 702 includes an I/O unit 704, a front-end unit 706, a scheduler unit 708, a work distribution unit 710, a hub 712, a crossbar 714, one or more general processing cluster 716 modules, and one or more memory partition unit 718 modules. The parallel processing unit 702 may be connected to a host processor or other parallel processing unit 702 modules via one or more high-speed NVLink 720 interconnects. The parallel processing unit 702 may be connected to a host processor or other peripheral devices via an interconnect 722. The parallel processing unit 702 may also be connected to a local memory comprising a number of memory 724 devices. In an embodiment, the local memory may comprise a number of dynamic random access memory (DRAM) devices. The DRAM devices may be configured as a high-bandwidth memory (HBM) subsystem, with multiple DRAM dies stacked within each device. The memory 724 may comprise logic to configure the parallel processing unit 702 to carry out aspects of the techniques disclosed herein.

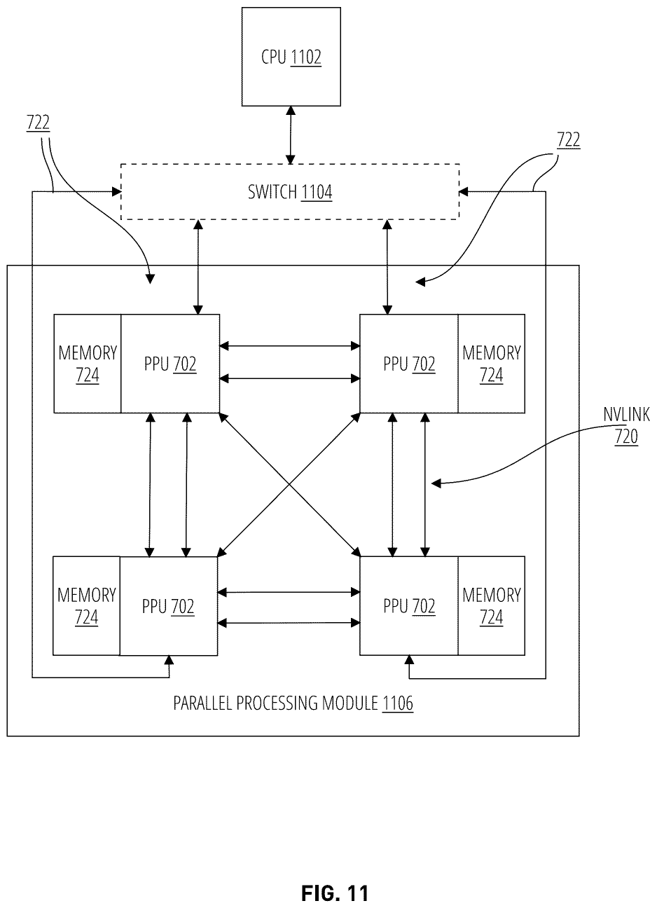

The NVLink 720 interconnect enables systems to scale and include one or more parallel processing unit 702 modules combined with one or more CPUs, supports cache coherence between the parallel processing unit 702 modules and CPUs, and CPU mastering. Data and/or commands may be transmitted by the NVLink 720 through the hub 712 to/from other units of the parallel processing unit 702 such as one or more copy engines, a video encoder, a video decoder, a power management unit, etc. (not explicitly shown). The NVLink 720 is described in more detail in conjunction with FIG. 11.

The I/O unit 704 is configured to transmit and receive communications (e.g., commands, data, etc.) from a host processor (not shown) over the interconnect 722. The I/O unit 704 may communicate with the host processor directly via the interconnect 722 or through one or more intermediate devices such as a memory bridge. In an embodiment, the I/O unit 704 may communicate with one or more other processors, such as one or more parallel processing unit 702 modules via the interconnect 722. In an embodiment, the I/O unit 704 implements a Peripheral Component Interconnect Express (PCIe) interface for communications over a PCIe bus and the interconnect 722 is a PCIe bus. In alternative embodiments, the I/O unit 704 may implement other types of well-known interfaces for communicating with external devices.

The I/O unit 704 decodes packets received via the interconnect 722. In an embodiment, the packets represent commands configured to cause the parallel processing unit 702 to perform various operations. The I/O unit 704 transmits the decoded commands to various other units of the parallel processing unit 702 as the commands may specify. For example, some commands may be transmitted to the front-end unit 706. Other commands may be transmitted to the hub 712 or other units of the parallel processing unit 702 such as one or more copy engines, a video encoder, a video decoder, a power management unit, etc. (not explicitly shown). In other words, the I/O unit 704 is configured to route communications between and among the various logical units of the parallel processing unit 702.

In an embodiment, a program executed by the host processor encodes a command stream in a buffer that provides workloads to the parallel processing unit 702 for processing. A workload may comprise several instructions and data to be processed by those instructions. The buffer is a region in a memory that is accessible (e.g., read/write) by both the host processor and the parallel processing unit 702. For example, the I/O unit 704 may be configured to access the buffer in a system memory connected to the interconnect 722 via memory requests transmitted over the interconnect 722. In an embodiment, the host processor writes the command stream to the buffer and then transmits a pointer to the start of the command stream to the parallel processing unit 702. The front-end unit 706 receives pointers to one or more command streams. The front-end unit 706 manages the one or more streams, reading commands from the streams and forwarding commands to the various units of the parallel processing unit 702.

The front-end unit 706 is coupled to a scheduler unit 708 that configures the various general processing cluster 716 modules to process tasks defined by the one or more streams. The scheduler unit 708 is configured to track state information related to the various tasks managed by the scheduler unit 708. The state may indicate which general processing cluster 716 a task is assigned to, whether the task is active or inactive, a priority level associated with the task, and so forth. The scheduler unit 708 manages the execution of a plurality of tasks on the one or more general processing cluster 716 modules.

The scheduler unit 708 is coupled to a work distribution unit 710 that is configured to dispatch tasks for execution on the general processing cluster 716 modules. The work distribution unit 710 may track a number of scheduled tasks received from the scheduler unit 708. In an embodiment, the work distribution unit 710 manages a pending task pool and an active task pool for each of the general processing cluster 716 modules. The pending task pool may comprise a number of slots (e.g., 32 slots) that contain tasks assigned to be processed by a particular general processing cluster 716. The active task pool may comprise a number of slots (e.g., 4 slots) for tasks that are actively being processed by the general processing cluster 716 modules. As a general processing cluster 716 finishes the execution of a task, that task is evicted from the active task pool for the general processing cluster 716 and one of the other tasks from the pending task pool is selected and scheduled for execution on the general processing cluster 716. If an active task has been idle on the general processing cluster 716, such as while waiting for a data dependency to be resolved, then the active task may be evicted from the general processing cluster 716 and returned to the pending task pool while another task in the pending task pool is selected and scheduled for execution on the general processing cluster 716.

The work distribution unit 710 communicates with the one or more general processing cluster 716 modules via crossbar 714. The crossbar 714 is an interconnect network that couples many of the units of the parallel processing unit 702 to other units of the parallel processing unit 702. For example, the crossbar 714 may be configured to couple the work distribution unit 710 to a particular general processing cluster 716. Although not shown explicitly, one or more other units of the parallel processing unit 702 may also be connected to the crossbar 714 via the hub 712.

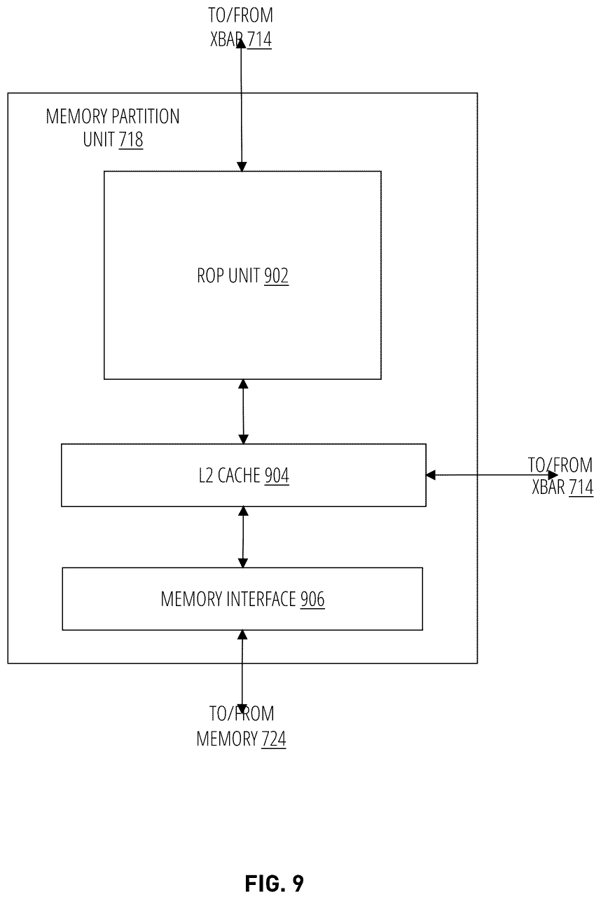

The tasks are managed by the scheduler unit 708 and dispatched to a general processing cluster 716 by the work distribution unit 710. The general processing cluster 716 is configured to process the task and generate results. The results may be consumed by other tasks within the general processing cluster 716, routed to a different general processing cluster 716 via the crossbar 714, or stored in the memory 724. The results can be written to the memory 724 via the memory partition unit 718 modules, which implement a memory interface for reading and writing data to/from the memory 724. The results can be transmitted to another parallel processing unit 702 or CPU via the NVLink 720. In an embodiment, the parallel processing unit 702 includes a number U of memory partition unit 718 modules that is equal to the number of separate and distinct memory 724 devices coupled to the parallel processing unit 702. A memory partition unit 718 will be described in more detail below in conjunction with FIG. 9.

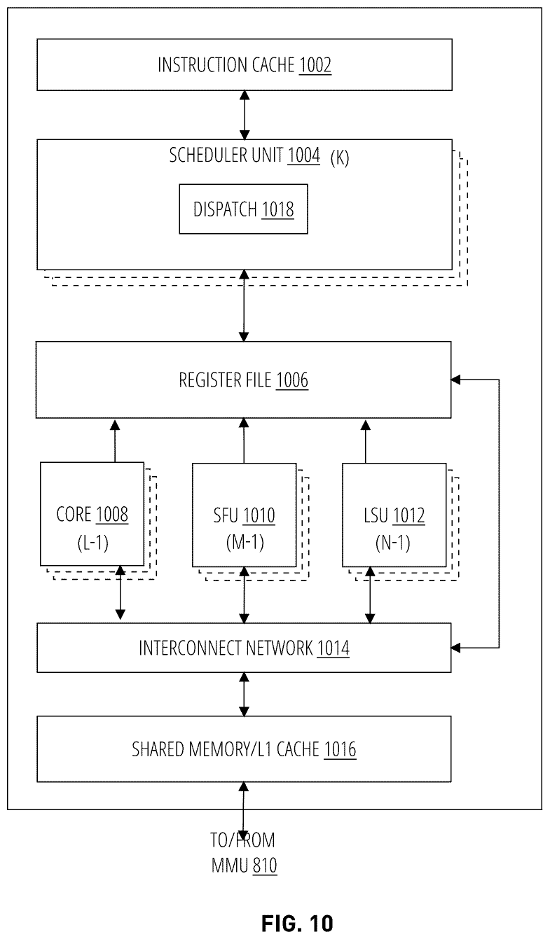

In an embodiment, a host processor executes a driver kernel that implements an application programming interface (API) that enables one or more applications executing on the host processor to schedule operations for execution on the parallel processing unit 702. In an embodiment, multiple compute applications are simultaneously executed by the parallel processing unit 702 and the parallel processing unit 702 provides isolation, quality of service (QOS), and independent address spaces for the multiple compute applications. An application may generate instructions (e.g., API calls) that cause the driver kernel to generate one or more tasks for execution by the parallel processing unit 702. The driver kernel outputs tasks to one or more streams being processed by the parallel processing unit 702. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. Threads and cooperating threads are described in more detail in conjunction with FIG. 10.

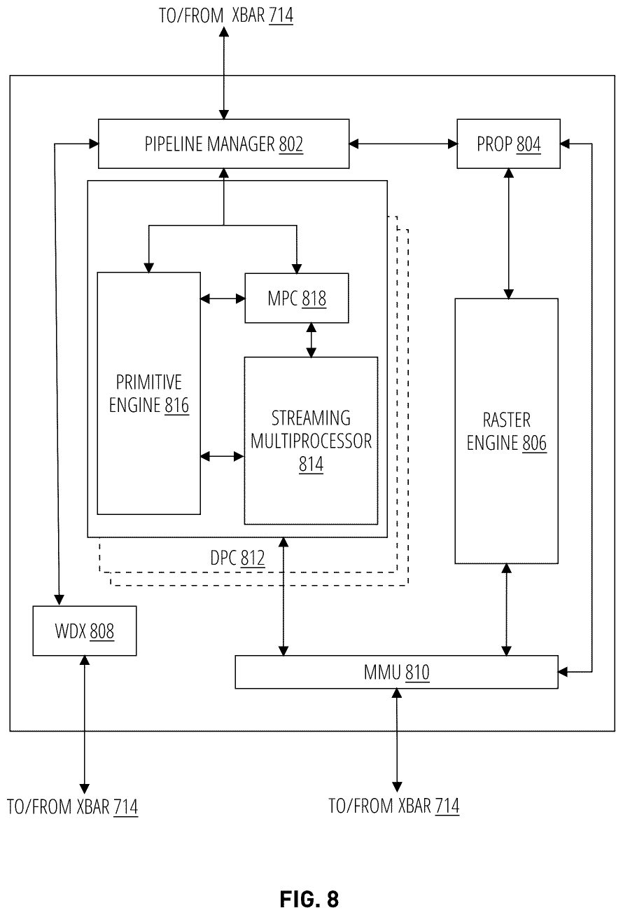

FIG. 8 depicts a general processing cluster 716 of the parallel processing unit 702 of FIG. 7, in accordance with an embodiment. As shown in FIG. 8, each general processing cluster 716 includes a number of hardware units for processing tasks. In an embodiment, each general processing cluster 716 includes a pipeline manager 802, a pre-raster operations unit 804, a raster engine 806, a work distribution crossbar 808, a memory management unit 810, and one or more data processing cluster 812. It will be appreciated that the general processing cluster 716 of FIG. 8 may include other hardware units in lieu of or in addition to the units shown in FIG. 8.

In an embodiment, the operation of the general processing cluster 716 is controlled by the pipeline manager 802. The pipeline manager 802 manages the configuration of the one or more data processing cluster 812 modules for processing tasks allocated to the general processing cluster 716. In an embodiment, the pipeline manager 802 may configure at least one of the one or more data processing cluster 812 modules to implement at least a portion of a graphics rendering pipeline. For example, a data processing cluster 812 may be configured to execute a vertex shader program on the programmable streaming multiprocessor 814. The pipeline manager 802 may also be configured to route packets received from the work distribution unit 710 to the appropriate logical units within the general processing cluster 716. For example, some packets may be routed to fixed function hardware units in the pre-raster operations unit 804 and/or raster engine 806 while other packets may be routed to the data processing cluster 812 modules for processing by the primitive engine 816 or the streaming multiprocessor 814. In an embodiment, the pipeline manager 802 may configure at least one of the one or more data processing cluster 812 modules to implement a neural network model and/or a computing pipeline.

The pre-raster operations unit 804 is configured to route data generated by the raster engine 806 and the data processing cluster 812 modules to a Raster Operations (ROP) unit, described in more detail in conjunction with FIG. 9. The pre-raster operations unit 804 may also be configured to perform optimizations for color blending, organize pixel data, perform address translations, and the like.

The raster engine 806 includes a number of fixed function hardware units configured to perform various raster operations. In an embodiment, the raster engine 806 includes a setup engine, a coarse raster engine, a culling engine, a clipping engine, a fine raster engine, and a tile coalescing engine. The setup engine receives transformed vertices and generates plane equations associated with the geometric primitive defined by the vertices. The plane equations are transmitted to the coarse raster engine to generate coverage information (e.g., an x, y coverage mask for a tile) for the primitive. The output of the coarse raster engine is transmitted to the culling engine where fragments associated with the primitive that fail a z-test are culled, and transmitted to a clipping engine where fragments lying outside a viewing frustum are clipped. Those fragments that survive clipping and culling may be passed to the fine raster engine to generate attributes for the pixel fragments based on the plane equations generated by the setup engine. The output of the raster engine 806 comprises fragments to be processed, for example, by a fragment shader implemented within a data processing cluster 812.

Each data processing cluster 812 included in the general processing cluster 716 includes an M-pipe controller 818, a primitive engine 816, and one or more streaming multiprocessor 814 modules. The M-pipe controller 818 controls the operation of the data processing cluster 812, routing packets received from the pipeline manager 802 to the appropriate units in the data processing cluster 812. For example, packets associated with a vertex may be routed to the primitive engine 816, which is configured to fetch vertex attributes associated with the vertex from the memory 724. In contrast, packets associated with a shader program may be transmitted to the streaming multiprocessor 814.

The streaming multiprocessor 814 comprises a programmable streaming processor that is configured to process tasks represented by a number of threads. Each streaming multiprocessor 814 is multi-threaded and configured to execute a plurality of threads (e.g., 32 threads) from a particular group of threads concurrently. In an embodiment, the streaming multiprocessor 814 implements a Single-Instruction, Multiple-Data (SIMD) architecture where each thread in a group of threads (e.g., a warp) is configured to process a different set of data based on the same set of instructions. All threads in the group of threads execute the same instructions. In another embodiment, the streaming multiprocessor 814 implements a Single-Instruction, Multiple Thread (SIMT) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The streaming multiprocessor 814 will be described in more detail below in conjunction with FIG. 10.

The memory management unit 810 provides an interface between the general processing cluster 716 and the memory partition unit 718. The memory management unit 810 may provide translation of virtual addresses into physical addresses, memory protection, and arbitration of memory requests. In an embodiment, the memory management unit 810 provides one or more translation lookaside buffers (TLBs) for performing translation of virtual addresses into physical addresses in the memory 724.

FIG. 9 depicts a memory partition unit 718 of the parallel processing unit 702 of FIG. 7, in accordance with an embodiment. As shown in FIG. 9, the memory partition unit 718 includes a raster operations unit 902, a level two cache 904, and a memory interface 906. The memory interface 906 is coupled to the memory 724. Memory interface 906 may implement 32, 64, 128, 1024-bit data buses, or the like, for high-speed data transfer. In an embodiment, the parallel processing unit 702 incorporates U memory interface 906 modules, one memory interface 906 per pair of memory partition unit 718 modules, where each pair of memory partition unit 718 modules is connected to a corresponding memory 724 device. For example, parallel processing unit 702 may be connected to up to Y memory 724 devices, such as high bandwidth memory stacks or graphics double-data-rate, version 5, synchronous dynamic random access memory, or other types of persistent storage.

In an embodiment, the memory interface 906 implements an HBM2 memory interface and Y equals half U. In an embodiment, the HBM2 memory stacks are located on the same physical package as the parallel processing unit 702, providing substantial power and area savings compared with conventional GDDR5 SDRAM systems. In an embodiment, each HBM2 stack includes four memory dies and Y equals 4, with HBM2 stack including two 128-bit channels per die for a total of 8 channels and a data bus width of 1024 bits.

In an embodiment, the memory 724 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where parallel processing unit 702 modules process very large datasets and/or run applications for extended periods.

In an embodiment, the parallel processing unit 702 implements a multi-level memory hierarchy. In an embodiment, the memory partition unit 718 supports a unified memory to provide a single unified virtual address space for CPU and parallel processing unit 702 memory, enabling data sharing between virtual memory systems. In an embodiment the frequency of accesses by a parallel processing unit 702 to memory located on other processors is traced to ensure that memory pages are moved to the physical memory of the parallel processing unit 702 that is accessing the pages more frequently. In an embodiment, the NVLink 720 supports address translation services allowing the parallel processing unit 702 to directly access a CPU's page tables and providing full access to CPU memory by the parallel processing unit 702.

In an embodiment, copy engines transfer data between multiple parallel processing unit 702 modules or between parallel processing unit 702 modules and CPUs. The copy engines can generate page faults for addresses that are not mapped into the page tables. The memory partition unit 718 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 724 or other system memory may be fetched by the memory partition unit 718 and stored in the level two cache 904, which is located on-chip and is shared between the various general processing cluster 716 modules. As shown, each memory partition unit 718 includes a portion of the level two cache 904 associated with a corresponding memory 724 device. Lower level caches may then be implemented in various units within the general processing cluster 716 modules. For example, each of the streaming multiprocessor 814 modules may implement an L1 cache. The L1 cache is private memory that is dedicated to a particular streaming multiprocessor 814. Data from the level two cache 904 may be fetched and stored in each of the L1 caches for processing in the functional units of the streaming multiprocessor 814 modules. The level two cache 904 is coupled to the memory interface 906 and the crossbar 714.

The raster operations unit 902 performs graphics raster operations related to pixel color, such as color compression, pixel blending, and the like. The raster operations unit 902 also implements depth testing in conjunction with the raster engine 806, receiving a depth for a sample location associated with a pixel fragment from the culling engine of the raster engine 806. The depth is tested against a corresponding depth in a depth buffer for a sample location associated with the fragment. If the fragment passes the depth test for the sample location, then the raster operations unit 902 updates the depth buffer and transmits a result of the depth test to the raster engine 806. It will be appreciated that the number of partition memory partition unit 718 modules may be different than the number of general processing cluster 716 modules and, therefore, each raster operations unit 902 may be coupled to each of the general processing cluster 716 modules. The raster operations unit 902 tracks packets received from the different general processing cluster 716 modules and determines which general processing cluster 1 that a result generated by the raster operations unit 902 is routed to through the crossbar 714. Although the raster operations unit 902 is included within the memory partition unit 718 in FIG. 9, in other embodiment, the raster operations unit 902 may be outside of the memory partition unit 718. For example, the raster operations unit 902 may reside in the general processing cluster 716 or another unit.

FIG. 10 illustrates the streaming multiprocessor 814 of FIG. 8, in accordance with an embodiment. As shown in FIG. 10, the streaming multiprocessor 814 includes an instruction cache 1002, one or more scheduler unit 1004 modules (e.g., such as scheduler unit 708), a register file 1006, one or more processing core 1008 modules, one or more special function unit 1010 modules, one or more load/store unit 1012 modules, an interconnect network 1014, and a shared memory/L1 cache 1016.

As described above, the work distribution unit 710 dispatches tasks for execution on the general processing cluster 716 modules of the parallel processing unit 702. The tasks are allocated to a particular data processing cluster 812 within a general processing cluster 716 and, if the task is associated with a shader program, the task may be allocated to a streaming multiprocessor 814. The scheduler unit 708 receives the tasks from the work distribution unit 710 and manages instruction scheduling for one or more thread blocks assigned to the streaming multiprocessor 814. The scheduler unit 1004 schedules thread blocks for execution as warps of parallel threads, where each thread block is allocated at least one warp. In an embodiment, each warp executes 32 threads. The scheduler unit 1004 may manage a plurality of different thread blocks, allocating the warps to the different thread blocks and then dispatching instructions from the plurality of different cooperative groups to the various functional units (e.g., core 1008 modules, special function unit 1010 modules, and load/store unit 1012 modules) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads ( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch 1018 unit is configured within the scheduler unit 1004 to transmit instructions to one or more of the functional units. In one embodiment, the scheduler unit 1004 includes two dispatch 1018 units that enable two different instructions from the same warp to be dispatched during each clock cycle. In alternative embodiments, each scheduler unit 1004 may include a single dispatch 1018 unit or additional dispatch 1018 units.

Each streaming multiprocessor 814 includes a register file 1006 that provides a set of registers for the functional units of the streaming multiprocessor 814. In an embodiment, the register file 1006 is divided between each of the functional units such that each functional unit is allocated a dedicated portion of the register file 1006. In another embodiment, the register file 1006 is divided between the different warps being executed by the streaming multiprocessor 814. The register file 1006 provides temporary storage for operands connected to the data paths of the functional units.

Each streaming multiprocessor 814 comprises L processing core 1008 modules. In an embodiment, the streaming multiprocessor 814 includes a large number (e.g., 128, etc.) of distinct processing core 1008 modules. Each core 1008 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic. In an embodiment, the core 1008 modules include 64 single-precision (32-bit) floating point cores, 64 integer cores, 32 double-precision (64-bit) floating point cores, and 8 tensor cores.

Tensor cores configured to perform matrix operations, and, in an embodiment, one or more tensor cores are included in the core 1008 modules. In particular, the tensor cores are configured to perform deep learning matrix arithmetic, such as convolution operations for neural network training and inferencing. In an embodiment, each tensor core operates on a 4×4 matrix and performs a matrix multiply and accumulate operation D=A′B+C, where A, B, C, and D are 4×4 matrices.

In an embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each streaming multiprocessor 814 also comprises M special function unit 1010 modules that perform special functions (e.g., attribute evaluation, reciprocal square root, and the like). In an embodiment, the special function unit 1010 modules may include a tree traversal unit configured to traverse a hierarchical tree data structure. In an embodiment, the special function unit 1010 modules may include texture unit configured to perform texture map filtering operations. In an embodiment, the texture units are configured to load texture maps (e.g., a 2D array of texels) from the memory 724 and sample the texture maps to produce sampled texture values for use in shader programs executed by the streaming multiprocessor 814. In an embodiment, the texture maps are stored in the shared memory/L1 cache 1016. The texture units implement texture operations such as filtering operations using mip-maps (e.g., texture maps of varying levels of detail). In an embodiment, each streaming multiprocessor 814 includes two texture units.

Each streaming multiprocessor 814 also comprises N load/store unit 1012 modules that implement load and store operations between the shared memory/L1 cache 1016 and the register file 1006. Each streaming multiprocessor 814 includes an interconnect network 1014 that connects each of the functional units to the register file 1006 and the load/store unit 1012 to the register file 1006 and shared memory/L1 cache 1016. In an embodiment, the interconnect network 1014 is a crossbar that can be configured to connect any of the functional units to any of the registers in the register file 1006 and connect the load/store unit 1012 modules to the register file 1006 and memory locations in shared memory/L1 cache 1016.

The shared memory/L1 cache 1016 is an array of on-chip memory that allows for data storage and communication between the streaming multiprocessor 814 and the primitive engine 816 and between threads in the streaming multiprocessor 814. In an embodiment, the shared memory/L1 cache 1016 comprises 128 KB of storage capacity and is in the path from the streaming multiprocessor 814 to the memory partition unit 718. The shared memory/L1 cache 1016 can be used to cache reads and writes. One or more of the shared memory/L1 cache 1016, level two cache 904, and memory 724 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory/L1 cache 1016 enables the shared memory/L1 cache 1016 to function as a high-throughput conduit for streaming data while simultaneously providing high-bandwidth and low-latency access to frequently reused data.

When configured for general purpose parallel computation, a simpler configuration can be used compared with graphics processing. Specifically, the fixed function graphics processing units shown in FIG. 7, are bypassed, creating a much simpler programming model. In the general purpose parallel computation configuration, the work distribution unit 710 assigns and distributes blocks of threads directly to the data processing cluster 812 modules. The threads in a block execute the same program, using a unique thread ID in the calculation to ensure each thread generates unique results, using the streaming multiprocessor 814 to execute the program and perform calculations, shared memory/L1 cache 1016 to communicate between threads, and the load/store unit 1012 to read and write global memory through the shared memory/L1 cache 1016 and the memory partition unit 718. When configured for general purpose parallel computation, the streaming multiprocessor 814 can also write commands that the scheduler unit 708 can use to launch new work on the data processing cluster 812 modules.

The parallel processing unit 702 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the parallel processing unit 702 is embodied on a single semiconductor substrate. In another embodiment, the parallel processing unit 702 is included in a system-on-a-chip (SoC) along with one or more other devices such as additional parallel processing unit 702 modules, the memory 724, a reduced instruction set computer (RISC) CPU, a memory management unit (MMU), a digital-to-analog converter (DAC), and the like.

In an embodiment, the parallel processing unit 702 may be included on a graphics card that includes one or more memory devices. The graphics card may be configured to interface with a PCIe slot on a motherboard of a desktop computer. In yet another embodiment, the parallel processing unit 702 may be an integrated graphics processing unit (iGPU) or parallel processor included in the chipset of the motherboard.

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 11 is a conceptual diagram of a processing system implemented using the parallel processing unit 702 of FIG. 7, in accordance with an embodiment. The processing system includes a central processing unit 1102, an switch 1104, and multiple parallel processing unit 702 modules each and respective memory 724 modules. The switch 1104 is depicted with dashed lines, indicating that it is optional in some embodiments.

The NVLink 720 provides high-speed communication links between each of the parallel processing unit 702 modules. Although a particular number of NVLink 720 and interconnect 722 connections are illustrated in FIG. 11, the number of connections to each parallel processing unit 702 and the central processing unit 1102 may vary. The switch 1104 interfaces between the interconnect 722 and the central processing unit 1102. The parallel processing unit 702 modules, memory 724 modules, and NVLink 720 connections may be situated on a single semiconductor platform to form a parallel processing module 1106. In an embodiment, the switch 1104 supports two or more protocols to interface between various different connections and/or links.

In another embodiment (not shown), the NVLink 720 provides one or more high-speed communication links between each of the parallel processing unit modules (parallel processing unit 702, parallel processing unit 702, parallel processing unit 702, and parallel processing unit 702) and the central processing unit 1102 and the switch 1104 (when present) interfaces between the interconnect 722 and each of the parallel processing unit modules. The parallel processing unit modules, memory 724 modules, and interconnect 722 may be situated on a single semiconductor platform to form a parallel processing module 1106. In yet another embodiment (not shown), the interconnect 722 provides one or more communication links between each of the parallel processing unit modules and the central processing unit 1102 and the switch 1104 interfaces between each of the parallel processing unit modules using the NVLink 720 to provide one or more high-speed communication links between the parallel processing unit modules. In another embodiment (not shown), the NVLink 720 provides one or more high-speed communication links between the parallel processing unit modules and the central processing unit 1102 through the switch 1104. In yet another embodiment (not shown), the interconnect 722 provides one or more communication links between each of the parallel processing unit modules directly. One or more of the NVLink 720 high-speed communication links may be implemented as a physical NVLink interconnect or either an on-chip or on-die interconnect using the same protocol as the NVLink 720.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 1106 may be implemented as a circuit board substrate and each of the parallel processing unit modules and/or memory 724 modules may be packaged devices. In an embodiment, the central processing unit 1102, switch 1104, and the parallel processing module 1106 are situated on a single semiconductor platform.

In an embodiment, each parallel processing unit module includes six NVLink 720 interfaces (as shown in FIG. 11, five NVLink 720 interfaces are included for each parallel processing unit module). The NVLink 720 may be operated exclusively for PPU-to-PPU communication as shown in FIG. 11, or some combination of PPU-to-PPU and PPU-to-CPU, when the central processing unit 1102 also includes one or more NVLink 720 interfaces.

In an embodiment, the NVLink 720 allows direct load/store/atomic access from the central processing unit 1102 to each parallel processing unit module's memory 724. In an embodiment, the NVLink 720 supports coherency operations, allowing data read from the memory 724 modules to be stored in the cache hierarchy of the central processing unit 1102, reducing cache access latency for the central processing unit 1102. In an embodiment, the NVLink 720 includes support for Address Translation Services (ATS), enabling the parallel processing unit module to directly access page tables within the central processing unit 1102. One or more of the NVLink 720 may also be configured to operate in a low-power mode.

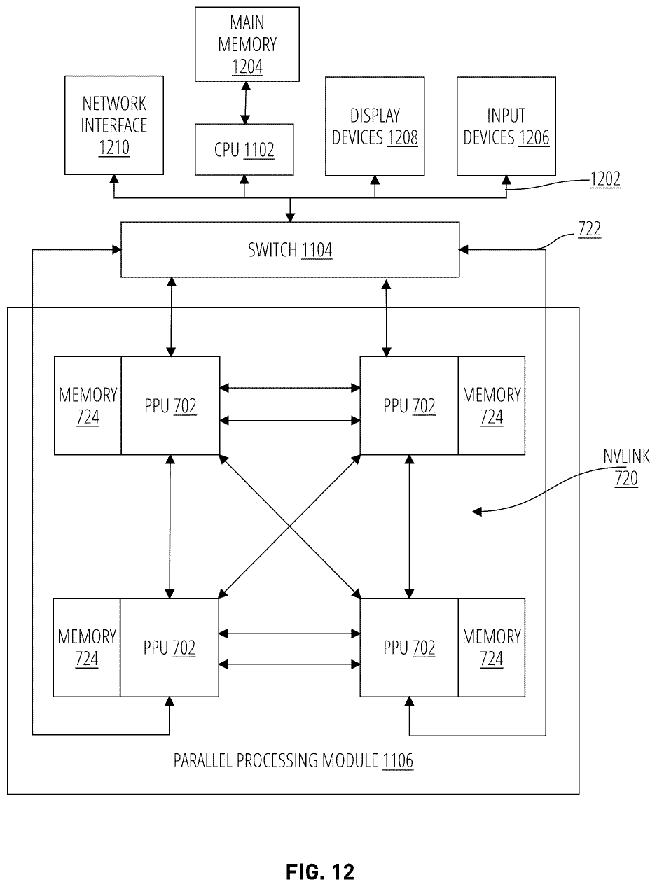

FIG. 12 depicts an exemplary processing system in which the various architecture and/or functionality of the various previous embodiments may be implemented. As shown, an exemplary processing system is provided including at least one central processing unit 1102 that is connected to a communications bus 1202. The communication communications bus 1202 may be implemented using any suitable protocol, such as PCI (Peripheral Component Interconnect), PCI-Express, AGP (Accelerated Graphics Port), HyperTransport, or any other bus or point-to-point communication protocol(s). The exemplary processing system also includes a main memory 1204. Control logic (software) and data are stored in the main memory 1204 which may take the form of random access memory (RAM). For simplicity of illustration, the main memory 1204 may be understood to comprise other forms of bulk memory, including non-volatile memory technologies.

The exemplary processing system also includes input devices 1206, the parallel processing module 1106, and display devices 1208, e.g. a conventional CRT (cathode ray tube), LCD (liquid crystal display), LED (light emitting diode), plasma display or the like. User input may be received from the input devices 1206, e.g., keyboard, mouse, touchpad, microphone, and the like. Each of the foregoing modules and/or devices may even be situated on a single semiconductor platform to form the exemplary processing system. Alternately, the various modules may also be situated separately or in various combinations of semiconductor platforms per the desires of the user.

Further, the exemplary processing system may be coupled to a network (e.g., a telecommunications network, local area network (LAN), wireless network, wide area network (WAN) such as the Internet, peer-to-peer network, cable network, or the like) through a network interface 1210 for communication purposes.

The exemplary processing system may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 1204 and/or the secondary storage. Such computer programs, when executed, enable the exemplary processing system to perform various functions. The main memory 1204, the storage, and/or any other storage are possible examples of computer-readable media (volatile and/or non-volatile, depending on the implementation).

The architecture and/or functionality of the various previous figures may be implemented in the context of a general computer system, a circuit board system, a game console system dedicated for entertainment purposes, an application-specific system, and/or any other desired system. For example, the exemplary processing system may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### LISTING OF DRAWING ELEMENTS

102 multi-view fusion logic
104 2D model
106 multi-view images
108 3D Gaussian encoder
110 3D Gaussians
112 3D feature extraction system
114 3D feature extraction network
116 3D semantic feature Gaussians
118 voxelizer
120 view-dependent filter
302 lifted 3D Gaussians
502 embedding adaptor
504 large language model
506 vision language model
602 video diffusion model
702 parallel processing unit
704 I/O unit
706 front-end unit
708 scheduler unit
710 work distribution unit
712 hub
714 crossbar
716 general processing cluster
718 memory partition unit
720 NVLink
722 interconnect
724 memory
802 pipeline manager
804 pre-raster operations unit
806 raster engine
808 work distribution crossbar
810 memory management unit
812 data processing cluster
814 streaming multiprocessor
816 primitive engine
818 M-pipe controller
902 raster operations unit
904 level two cache
906 memory interface
1002 instruction cache
1004 scheduler unit
1006 register file
1008 core
1010 special function unit
1012 load/store unit
1014 interconnect network
1016 shared memory/L1 cache
1018 dispatch
1102 central processing unit
1104 switch
1106 parallel processing module
1202 communications bus
1204 main memory
1206 input devices
1208 display devices
1210 network interface

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media configured with machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory, and firmware are examples of logic. Logic specifically excludes pure signals or software per se (however does not exclude non-transitory machine memories comprising software and thereby forming statutory configurations of matter). Logic symbols in the drawings should be understood to have their ordinary interpretation in the art in terms of functionality and various structures that may be utilized for their implementation, unless otherwise indicated.

Within this disclosure, different entities (which may variously be referred to as “units,” “circuits,” other components, etc.) may be described or claimed as “configured” to perform one or more tasks or operations. This formulation-[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112 (f) for that claim element. Accordingly, claims in this application that do not otherwise include the “means for” [performing a function] construct should not be interpreted under 35 U.S.C § 112 (f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

Although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the disclosure as claimed. The scope of inventive subject matter is not limited to the depicted embodiments but is rather set forth in the following Claims.

What is claimed is:

1. A system comprising:
a three dimensional (3D) feature extraction network configured to extract semantic features from 3D Gaussians;
logic configured to:
distill scene features from a two-dimensional (2D) model; and
minimize a distance between the semantic features extracted from the 3D Gaussians and the scene features.

2. The system of claim 1, wherein the 3D feature extraction network is configured to extract the semantic features from the 3D Gaussians in a single forward pass.

3. The system of claim 1, further comprising:
a 3D Gaussian encoder configured to transform the scene features into the 3D Gaussians.

4. The system of claim 3, further comprising:
a voxelizer configured to voxelize the 3D Gaussians.

5. The system of claim 3, further comprising:
a filter configured to perform view-dependent selection on the 3D Gaussians.

6. The system of claim 1, further comprising:
logic to determine a distance between the semantic features extracted from the 3D Gaussians and splats of the 3D Gaussians.

7. The system of claim 6, wherein the 3D feature extraction network is configured using a loss comprising (a) the distance between the semantic features extracted from the 3D Gaussians and the scene features, and (b) the distance between the semantic features extracted from the 3D Gaussians and splats of the 3D Gaussians.

8. The system of claim 1, wherein the 2D model comprises an interchangeable adaptor configured to map 2D features into a particular embedding space.

9. A process comprising:
extracting semantic features from 3D Gaussians that encode a visual scene;
distilling features of the visual scene from a two-dimensional model; and
minimizing a distance between the semantic features extracted from the 3D Gaussians and the visual scene features to configure a 3D feature extraction network.

10. The process of claim 9, further comprising:
extracting the semantic features from the 3D Gaussians in a single forward pass of the 3D feature extraction network.

11. The process of claim 9, further comprising:
transforming the features of the visual scene into the 3D Gaussians.

12. The process of claim 11, further comprising:
voxelizing the 3D Gaussians.

13. The process of claim 11, further comprising:
performing view-dependent selection on the 3D Gaussians.

14. The process of claim 9, further comprising:
minimizing a distance between semantic features extracted from the 3D Gaussians and splats of the 3D Gaussians.

15. The process of claim 14, further comprising:
training the 3D feature extraction network using a loss comprising (a) the distance between the semantic features extracted from the 3D Gaussians and the visual scene features, and (b) the distance between the semantic features extracted from the 3D Gaussians and splats of the 3D Gaussians.

16. The process of claim 9, further comprising:
configuring the 2D model with an interchangeable adaptor that maps 2D features into a particular embedding space.

17. A non-volatile machine-readable memory comprising instructions that, when applied to one or more data process of a computer system, configure the computer system to:
extract semantic features from 3D Gaussians that encode a visual scene;
distill features of the visual scene from a two-dimensional model; and
minimize a distance between the semantic features extracted from the 3D Gaussians and the visual scene features to configure a 3D feature extraction network.

18. The non-volatile machine-readable memory of claim 17 further comprising instructions that configure the computer system to:
extract the semantic features from the 3D Gaussians in a single forward pass of the 3D feature extraction network.

19. The non-volatile machine-readable memory of claim 17 further comprising instructions that configure the computer system to:
minimize a distance between semantic features extracted from the 3D Gaussians and splats of the 3D Gaussians.

20. The non-volatile machine-readable memory of claim 17 further comprising instructions that configure the computer system to:
configure the 2D model with an interchangeable adaptor that maps 2D features into a particular embedding space.
